(19) United States
(12) Patent Application Publication
(10) Pub. No.: US 2007/0070000 A1
(43) Pub. Date: Mar. 29, 2007

(54) Image display device

(75) Inventors: Tomoki Nakamura, Chiba (JP); Toshiaki Kusunoki, Tokorozawa (JP); Masakazu Sagawa, Inagi (JP); Yuichi Inoue, Mobara (JP); Toshimitsu Watanabe, Yokohama (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/524,720

(22) Filed: Sep. 20, 2006

(30) Foreign Application Priority Data
Sep. 27, 2005 (JP) 2005-279191

(51) Int. Cl. G09G 3/34

(52) U.S. Cl. 345/84

(57) ABSTRACT

The present invention provides an image display device which suppresses the generation of sparks between end portions of divided portions and an anode when data signal lines are divided in two. Within a display region, between scanning lines GAN, GB1, data signal lines are divided in two in one direction of the data signal lines, that is, into upper data signal lines DA and lower data signal lines DB. Assuming a width of the data signal lines DA, DB as W, and a distance between opposedly-facing end portions of the divided electrode portions as S, and a pitch of the data signal lines as P, by establishing a relationship S≦W/2, the influence of a potential attributed to an abnormal charge which concentrates on the end portion of the data signal line spreads radially and does not extend to a center portion of the divided portion thus suppressing an abnormal discharge.

### BACKGROUND OF THE INVENTION

The present invention relates to a self-luminous-type flat-panel image display device, and more particularly to an image display device which has thin-film-type electron sources arranged in a matrix array.

As a self-luminous-type flat-panel display (FPD) which includes electron sources arranged in a matrix array, there has been known a field emission type image display device (FED: Field Emission Display) and an electron emission type image display device which use minute and integratable cold cathodes. Here, as the cold cathodes which are used in such image display devices, thin film electron sources of a Spindt type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor layer-metal or the like have been used.

The FPD includes a display panel which is constituted of a back panel which includes the electron sources described above, a face panel which includes phosphor layers and an anode which forms an acceleration voltage for allowing electrons emitted from the electron sources to impinge on the phosphor layers, and a sealing frame for sealing an inner space formed by opposing surfaces of both panels into a given vacuum state. The back panel includes the above-mentioned electron sources which are formed on aback substrate, and the face panel includes the phosphor layers which are formed on a face substrate and the anodes which form the acceleration voltage for forming an electric field which allows the electrons emitted from the electron sources to impinge on the phosphor layers. The FPD is constituted by combining a drive circuit with the display panel.

The individual electron source forms a pair with a corresponding phosphor layer so as to constitute a unit pixel. Usually, one pixel (one color pixel) is constituted of unit pixels of three colors of red (R), green (G) and blue (B). Here, in the case of the one color pixel, the unit pixel (R, G, B) is also referred to as a sub pixel.

A distance between the back panel and the face panel is held at a predetermined distance by members referred to as partition walls. The partition wall is formed of a plate-like body which is made of an insulation material such as glass, and ceramics or of a member having some conductivity. Usually, the partition walls are arranged at positions which do not impede an operation of pixels for every other plurality of pixels.

### SUMMARY OF THE INVENTION

In such a kind of image display device, on a main surface of the back substrate, a plurality of image signal lines which extend in one direction (for example, longitudinal direction or vertical direction) and are arranged in parallel to each other in another direction (for example, lateral direction or horizontal direction) perpendicular to the one direction and to which image signals are supplied, and a plurality of scanning signal lines which extend in another direction described above, are arranged in parallel to each other in the one direction described above, are mounted on an upper layer of the image signal lines in an insulating manner and to which scanning lines are applied sequentially are formed. Further, by arranging the partition walls over the scanning signal lines and in the extending direction of the scanning signal lines, the back panel is constituted.

Further, on the main surface of the face substrate, the phosphor layers which are formed in apertures of a light blocking film (black matrix) in a matrix array corresponding to respective electron sources mounted on the back substrate and the anode to which an acceleration voltage for directing the electrons emitted from the electron sources to the phosphor layer is applied are formed thus constituting the face panel.

In the FDP, between the electron sources and the anode, the acceleration voltage (anode voltage) of 5 kV to 10 kV is applied. In the electron emission type FPD, the light emission brightness of the phosphor is proportional to the anode voltage. In this electron emission type FPD, the anode voltage is set lower than an anode voltage of a color cathode ray tube (CRT) which uses the same light emission principle as the FPD and hence, to obtain a bright display image, a value of a drive current which flows in the image signal lines becomes large. Further, along with the increase of a wiring length of the image signal line or along with the increase of a distance from a power supply end, a voltage drop attributed to the line resistance is increased and hence, the irregularities are generated in the display brightness. The generation of the irregularities in brightness is remarkably increased along with the large-sizing of a screen size.

On the other hand, when the current value is increased to obtain the bright display image, the phosphors are largely damaged. Here, to avoid the increase of the damages, it is effective to divide the image signal lines in two and to drive the two-split image signal lines simultaneously. This is because that such driving can increase the brightness by prolonging the light emission time of the phosphors and can lower a peak current. However, when the image signal lines are divided in two, a potential change at facing ends of divided portions of the image signal lines appears with respect to the anode and hence, a spark is generated between the end portions and the anode thus causing the rupture of pixels.

Accordingly, it is an object of the invention to provide an image display device which can suppress the generation of a spark between end portions of divided portions of image signal lines when the image signal lines are divided in two and an anode, thus enabling high brightness image display.

In the invention, image signal lines which are formed below scanning signal lines are divided in two within a display region, and the electrode arrangement at a divided portion when the image signal lines are divided in two has a specific relationship. Further, the invention prevents end portions of the divided portion from being viewed from the anode side by covering the divided portions with the scanning lines.

The typical constitutions of the invention are as follows.
(1) In the invention, the image signal lines are divided in two in one direction of the image signal lines within a display region. Further, assuming a width of the image signal line as W and a distance between opposedly-facing end portions of the divided portions as S, a following relationship is established.
   S≦W/2
(2) Further, in the constitution (1), assuming the width of the image signal line as W, the distance between the opposedly-facing end portions of the divided portions as S and a pitch of the image signal lines in another direction (direction orthogonal to the one direction) as P, a following relationship is established.
   S≧P−W
(3) In the invention, the image signal lines are divided in two in one direction of the image signal lines within the display region, and opposedly-facing end portions of the two-divided portions are covered with the scanning signal line so as to prevent the opposedly-facing portions from being viewed from the face panel.
(4) In constituting one square color pixel using three electron sources, a following relationship is established.
   2P+W≧S≧P−W
(5) The electron source is formed of a thin-film-type electron emission element which includes the stacked structure constituted of a lower electrode, an upper electrode and an electron acceleration layer which is sandwiched between the lower electrode and the upper electrode, and emits electrons from the upper electrode when voltages are applied between the lower electrode and the upper electrode.

The generation of an imbalance of an electric field between the end portions of the two-divided image signal lines and the anode can be reduced and hence, it is possible to suppress the generation of sparks attributed to the division of the image signal lines. As a result, it is possible to increase an anode voltage and hence, a high brightness display at a low current value can be realized. Further, by covering the end portions of the two-divided image signal lines with the scanning signal lines, it is possible to suppress the generation of the sparks between the end portions and the anode. Further, it is possible to achieve the extension of a service life by suppressing the current value.

### BRIEF DESCRIPTION OF THE DRAWING

FIG. 1 is a plan view of a back panel for explaining an image display device of the invention;

FIG. 2 is an enlarged view of a C portion shown in FIG. 1 for explaining an embodiment 1 of the invention;

FIG. 3 is a view for explaining an arrangement relationship at opposedly-facing portions of an upper data signal line and a lower data signal line in FIG. 2;

FIG. 4 is an enlarged view corresponding to the C portion shown in FIG. 1 for explaining an embodiment 2 of the invention;

FIG. 5 is an enlarged view corresponding to the C portion shown in FIG. 1 for explaining an embodiment 3 of the invention;

FIG. 6 is a developed perspective view for explaining an example of the whole constitution of a full-color image display device; and

FIG. 7 is a cross-sectional view for explaining an example of the constitution of electron sources formed on a back panel of the invention.

### DESCRIPTION OF THE PREFERRED EMBODIMENTS

Hereinafter, preferred embodiments of the invention are explained in detail in conjunction with drawings showing the embodiments.

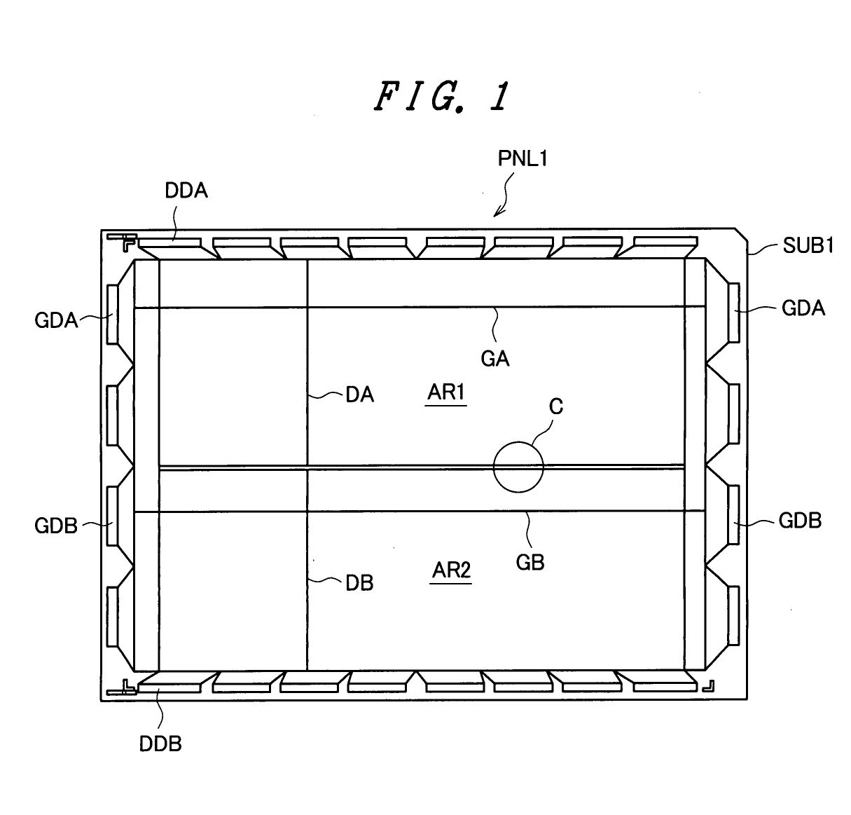

FIG. 1 is a plan view of a back panel for explaining an image display device of the invention. The explanation of a face panel is described later. A back panel PNL1 forms a back substrate SUB1 which has a display region thereof divided in two regions, that is, an upper display region AR1 and a lower display region AR2 in the vertical direction in FIG. 1 as one direction. Here, symbol DA indicates image signal lines (hereinafter, also referred to as merely signal lines or data lines) in the upper display region AR1, symbol DB indicates data lines in the lower display region AR2, symbol GA indicates scanning signal lines (hereinafter, also referred to as scanning lines) in the upper display region AR1 and symbol GB indicates scanning lines in the lower display region AR2.

Around these display regions AR1 and AR2, upper data line drive circuits DDA which supply image signals (display signals) to the upper data lines DA are mounted on an upper long side, and lower data line drive circuits DDB which supply image signals (display signals) to the lower data lines DB are mounted on a lower long side. The upper data lines DA and the lower data lines DB are mechanically and electrically separated from each other in the vicinity of a boundary between the display regions AR1 and AR2. Further, upper scanning line drive circuits GDA which supply the scanning signals to the upper scanning lines GA are mounted on both sides of the upper side of short sides, and lower scanning line drive circuits GDB which supply the scanning signals to the lower scanning lines GB are mounted on both sides of the lower side of short sides. Here, electron sources which constitute pixels are formed in the vicinity of intersecting portions of the upper and lower data lines DA, DB and the upper and lower scanning lines GA, GB.

In the constitution in FIG. 1, the display signals (image signals) are respectively supplied from the upper-data-line drive circuits DDA and the lower-data-line drive circuits DDB to the upper data lines DA in the upper display region AR1 and the lower data lines DB in the lower display region AR2. Further, the scanning signals are respectively applied to the upper and lower scanning lines GA, GB from the upper scanning line drive circuits GDA and the lower scanning line drive circuits GDB. In this embodiment, in applying the scanning signals, a so-called same-direction parallel simultaneous scanning method is adopted. That is, the scanning signal is simultaneously applied to the scanning lines in the upper display region AR1 and the lower display region AR2, wherein in each display region, the scanning signal is sequentially applied to the scanning lines from the uppermost scanning line. It is also possible to adopt other scanning method in applying the scanning signals.

### Embodiment 1

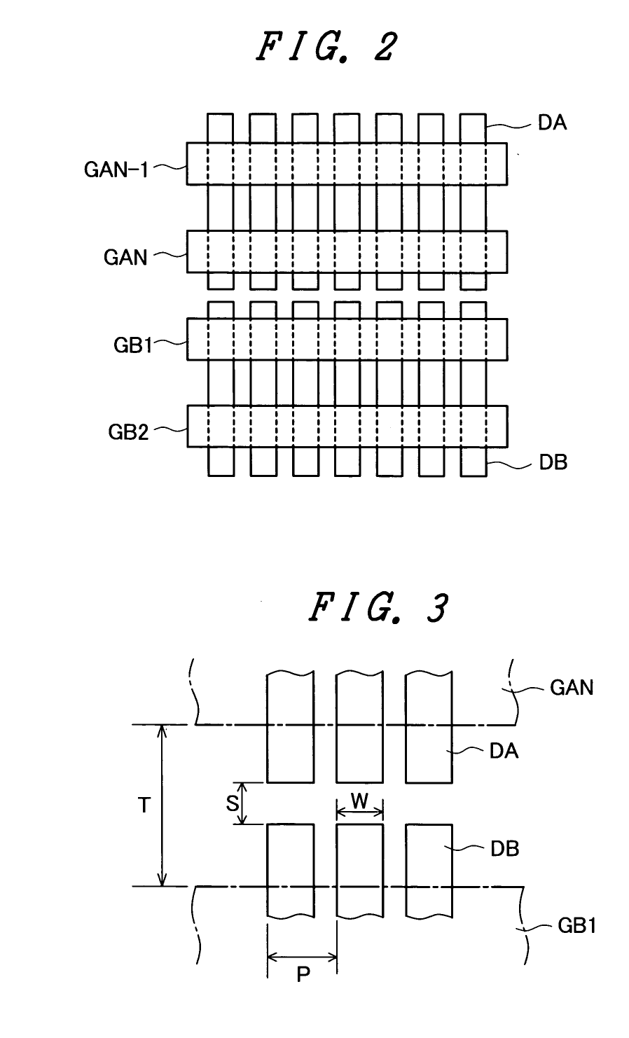

FIG. 2 is an enlarged view of a C portion shown in FIG. 1 for explaining an embodiment 1 of the invention. In FIG. 2, the data lines in the display region are divided in two data lines (upper data lines DA and lower data lines DB) at the center thereof. Here, symbols GAN-1 and GAN indicate the upper scanning lines, and symbols GB1 and GB2 indicate the lower scanning lines. The lowermost upper scanning line GAN of the upper scanning lines and the uppermost lower scanning line GB1 of the lower scanning lines are arranged close to each other while sandwiching the opposedly-facing ends of the upper data lines DA and the lower data lines DB therebetween.

FIG. 3 is a view for explaining an arrangement relationship of the opposedly-facing portion of the upper data signal line and the lower data signal line in FIG. 2. Here, in FIG. 3, the lowermost upper scanning line GAN out of the upper scanning lines and the uppermost lower scanning line GB1 out of the lower scanning lines are indicated by imaginary lines. A distance between the lowermost upper scanning line GAN of the upper scanning lines and the uppermost lower scanning line GB1 of the lower scanning lines is indicated by symbol T.

In the embodiment 1, the same-direction parallel simultaneous scanning method is applied to the upper and lower display regions. In such a scanning method, potentials of the upper data lines DA and the lower data lines DB at the opposedly-facing portions (end portions) thereof with respect to the anode differ from each other. In the embodiment 1, assuming widths of the upper data lines DA and the lower data lines DB as W, a distance between opposedly-facing end portions of the divided portions as S, and arrangement pitches (pitches in another direction) of the upper and lower image signal lines as P, the following relationship is established.
S≦W/2

Still further, by establishing a relationship S≧P−W, also between the divided data lines, a distance equal to the distance between the neighboring data lines is maintained and hence, it is possible to ensure a line to line withstand pressure. Further, the distance between the divided portions is smaller that the distance between the scanning lines and hence, as later explained in an embodiment 2, it is possible to conceal the divided portions directly below the scanning line.

The data lines and the scanning lines are insulated from each other by an insulator layer. However, when the distance S between the opposedly-facing end portions is larger than the width W of the lower data lines DB, a surface charge of the insulator which exists at the divided portions of the data lines becomes unstable thus causing an abnormal discharge. To cope with the abnormal discharge, it is only necessary to stabilize the potentials of the divided portions. By adopting the constitution of the embodiment 1, an influence of the potentials of outer peripheral portions of the data lines spreads radially due to the Coulomb's law and hence, the stabilization of the potentials can be ensured at also center portions of the divided portions thus suppressing the abnormal discharge. That is, the potentials attributed to the abnormal charge which concentrate on the end portions of the divided data lines do not extend to the center portions of the divided portions of the data lines thus stabilizing the potentials of the divided portions.

### Embodiment 2

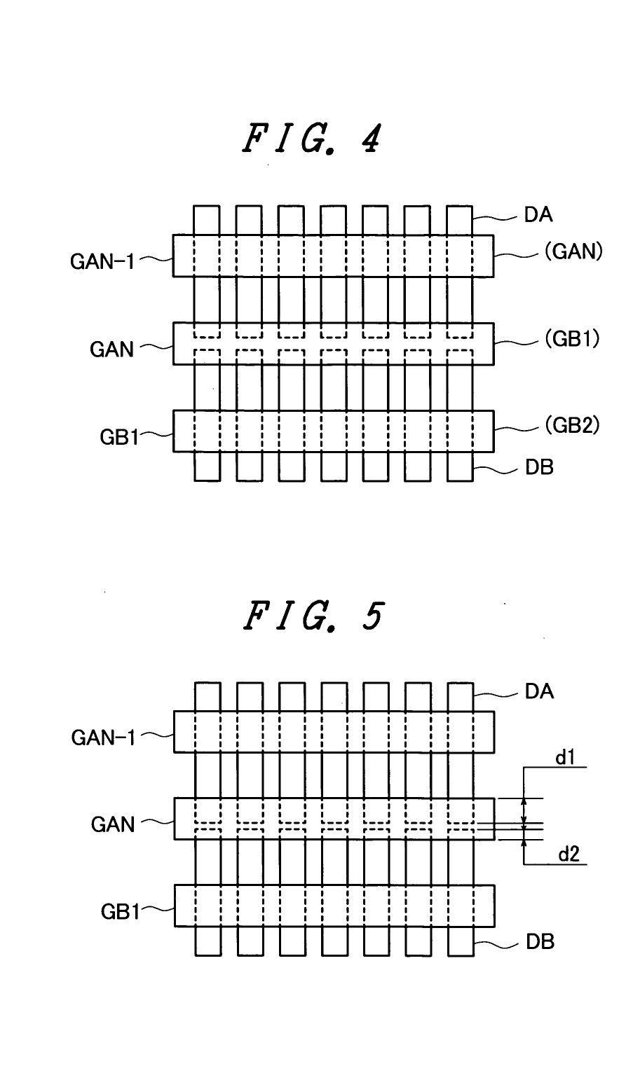

FIG. 4 is an enlarged view corresponding to the C portion shown in FIG. 1 for explaining an embodiment 2 of the invention. In the embodiment 2, the divided portions of the upper data lines DA and the lower data lines DB are covered with the scanning line GAN. In the embodiment 2, the divided portions of the data lines are covered with the scanning line GAN which is arranged at the lowermost end in the upper display region AR1. However, in place of the above-mentioned constitution, the divided portions may be covered with the scanning line GB1 which is arranged at the uppermost end in the lower display region AR2. The above-mentioned constitution is shown on a right side in FIG. 4.

Due to such a constitution, the opposedly-facing end portions of the divided signal lines are not viewed from the anode side and hence, it is possible to effectively suppress the generation of the sparks between the end portions and the anode. Here, by applying the arrangement dimension described in the embodiment 1 to the embodiment 2, it is possible to further efficiently suppress the generation of the sparks.

Further, when one square color pixel is constituted of three electron sources, a size of one color pixel becomes 3P. Here, it is necessary to ensure distance between the scanning lines which is substantially equal to the distance between the signal lines and hence, a largest width of the scanning line is set so as to satisfy a relationship 3P−(P−W)=2P+W. To surely cover the divided portions of the signal lines with the scanning lines, it is necessary to set the width between the opposedly-facing portions of the divided portions smaller than the width of the scanning line and hence, due to the above-mentioned relationship S≧P−W, a relationship 2P+W≧S≧P−W is established.

Due to the constitution described in the embodiment 2, the generation of sparks is suppressed and hence, the withstand pressure between the data lines is ensured whereby it is possible to enhance the reliability thus realizing the high anode voltage. As a result, it is possible to obtain an image display device which can realize a display of high brightness with a low current and a prolonged service time.

### Embodiment 3

FIG. 5 is an enlarged view corresponding to the C portion shown in FIG. 1 for explaining an embodiment 3 of the invention. In the embodiment 3, in covering the divided portions of the upper data lines DA and the lower data lines DB with the scanning lines GAN, the opposedly-facing portions of the data lines which are covered with the lowermost scanning line GAN in the upper display region are displaced to the scanning line GB1 side which is arranged on the uppermost portion in the lower display region so as to satisfy a relationship d1>d2.

According to the embodiment 3, in addition to the advantageous effects of the embodiment 2, it is possible to surely perform the selection of the pixels by the scanning line GAN.

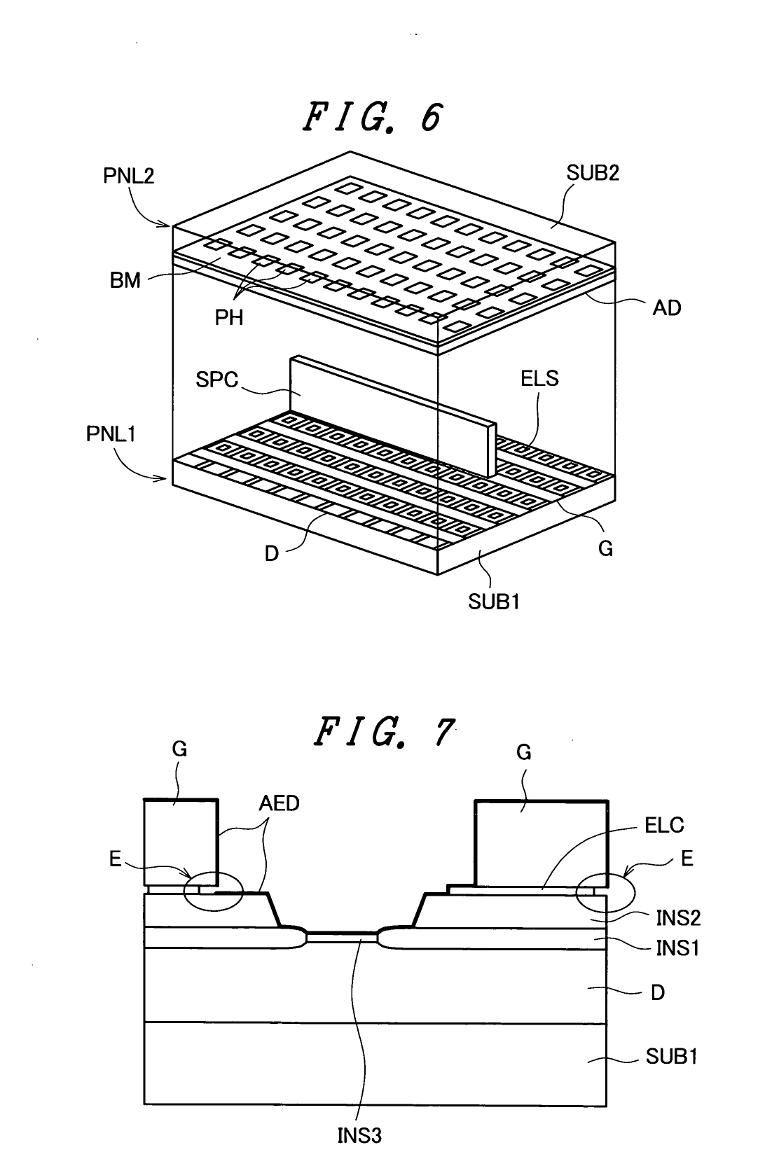

FIG. 6 is a developed perspective view for explaining an example of the whole constitution of a full-color image display device. A back panel PNL1 includes, on a main surface of the back substrate SUB1 which constitutes a first substrate of the back panel PNL1, a plurality of scanning lines G which extends in one direction, is arranged in parallel to each other in another direction orthogonal to the one direction and to which scanning signals are sequentially applied in another direction, a plurality of data lines D which extend in another direction and are arranged in parallel to each other in the one direction to intersect the scanning lines G, and electron sources ELS which are arranged in the vicinity of respective intersecting portions of the scanning lines G and the data lines D.

Further, a face panel PNL2 forms three sub pixels (sub pixels) PH of three colors (red (R), green (G), blue (B)) which are defined from each other using a light blocking film (black matrix) BM, and an anode (anode) AD on a main surface of the face substrate SUB2 which constitutes a second substrate. In such a constitutional example, spacers SPC are mounted on the scanning lines G of the back panel PNL1 along the scanning lines G, and the both panels are sealed by a sealing frame not shown in the drawings with a predetermined distance therebetween.

FIG. 7 is a cross-sectional view for explaining a constitutional example of electron sources formed on the back panel of the invention. In FIG. 7, on the data lines D which are formed on the main surface of the back substrate SUB1, the scanning lines G are formed to cross the data lines D with insulating layer INS1 and insulating layer INS2 being interposed between the scanning lines G and the data lines D. The electron source ELS shown in FIG. 6 is constituted of a lower portion electrode which is formed of a portion of the data lines D, an upper portion electrode AED which is connected through a supply source electrode ELC of the scanning line G and a tunnel insulating film INS3 which is formed of a thin film portion of the insulating film INS1. Here, a portion which is surrounded by symbol E in FIG. 7 shows a divided portion which is divided from the neighboring pixel, wherein by forming the upper portion electrode AED using a CVD method in a state that an end periphery of the connecting electrode ELC at the adjacent pixel side is retreated from the scanning lines G, the upper electrode AED is separated in self-alignment between the adjacent pixels.

In these embodiments described heretofore, the structure which adopts an MIM-type electron source is exemplified. However, the invention is not limited to the above-mentioned embodiments, and the invention is applicable to the self-luminous-type FPD which adopts the above-mentioned various kinds of electron sources in the same manner as the embodiment of the invention.

What is claimed is:

1. An image display device comprising:
a back panel having a back substrate on which a plurality of image signal lines which extend in one direction, are arranged in parallel to each other in another direction orthogonal to the one direction and to which image signals are supplied, a plurality of scanning signal lines which are formed over the image signal lines in an insulating manner in a state that the scanning lines extend in another direction and are arranged in parallel to each other in the one direction, and to which scanning signals are sequentially applied, electron sources which are arranged in the vicinity of respective intersecting portions of the image signal lines and the scanning signal lines and are arranged in a matrix array to constitute a display region, and a drive circuit which is mounted outside the display region;
a face panel having a face substrate which includes phosphor layers which are arranged in a matrix array corresponding to the respective electron sources, and anodes to which an acceleration voltage which directs electrons emitted from the electron sources to the phosphor layers is applied;
a sealing frame which is interposed between peripheries of the back panel and the face panel and holds an inner space which is defined by the back panel and the face panel which face each other with a predetermined distance therebetween in a predetermined vacuum state; and
partition walls which are provided between the back panel and the face panel for holding the predetermined distance, wherein
the image signal lines are divided in two in the one direction of the image signal lines within the display region, and assuming a width of the image signal line as W and a distance between opposedly-facing end portions of the divided portions of the image signal lines as S, the following relationship is established,
S≦W/2.

2. An image display device according to claim 1, wherein assuming the width of the image signal line as W, the distance between the opposedly-facing end portions of the divided portions as S and a pitch of the pixel signal lines in another direction of the image signal lines as P, the following relationship is established,
S≧P−W.

3. An image display device comprising:
a back panel having a back substrate on which a plurality of image signal lines which extend in one direction, are arranged in parallel to each other in another direction orthogonal to the one direction and to which image signals are supplied, a plurality of scanning signal lines which are formed over the image signal lines in an insulating manner in a state that the scanning lines extend in another direction and are arranged in parallel to each other in the one direction, and to which scanning signals are sequentially applied, electron sources which are arranged in the vicinity of respective intersecting portions of the image signal lines and the scanning signal lines and are arranged in a matrix array to constitute a display region, and a drive circuit which is mounted outside the display region;
a face panel having a face substrate which includes phosphor layers which are arranged in a matrix array corresponding to the respective electron sources, and anodes to which an acceleration voltage which directs electrons emitted from the electron sources to the phosphor layers is applied;
a sealing frame which is interposed between peripheries of the back panel and the face panel and holds an inner space which is defined by the back panel and the face panel which face each other with a predetermined distance therebetween in a predetermined vacuum state; and
partition walls which are provided between the back panel and the face panel for holding the predetermined distance, wherein
the image signal lines are divided in two in the one direction of the image signal lines within the display region, and opposedly-facing end portions of the two-divided portions of the image signal lines as viewed from the face panel are covered with the scanning signal line.

4. An image display device according to claim 3, wherein assuming the width of image signal line as W, the distance between the opposedly-facing end portions of the divided portions as S and a pitch of the pixel signal line in another direction of the image signal lines as P, the following relationship is established,
S≧P−W.

5. An image display device according to claim 4, wherein the following relationship is established with respect to one square color pixel which is constituted of the three electron sources,
2P+W≧S≧P−W.

6. An image display device according to claim 1, wherein the electron source is a thin-film-type electron emission element which includes a lower electrode, an upper electrode and an electron acceleration layer which is sandwiched between the lower electrode and the upper electrode, and emits electrons from the upper electrode when voltages are applied between the lower electrode and the upper electrode.

7. An image display device according to claim 1, wherein the partition wall is arranged on the scanning signal line while being divided in plural numbers.

8. An image display device according to claim 1, wherein the phosphor layers formed on the face panel are constituted of phosphor layers of three colors consisting of red, green and blue, and the respective phosphor layers are defined by a light blocking layer.
